(19) United States
(12) Patent Application Publication
(10) Pub. No.: US 2026/0214700 A1
(43) Pub. Date: Jul. 23, 2026

(54) OPTIMIZING PAYLOAD FOR PERIODIC ADVERTISING SYNCHRONIZATION

(71) Applicant: QUALCOMM Incorporated, San Diego, CA (US)

(72) Inventors: Zhuxian GU, Suzhou (CN); Nicolas GRAUBE, Cambridge (GB); Zaiyong CHEN, Shanghai (CN); Zhaoming YANG, Shanghai (CN); Jie ZHANG, Shanghai (CN); Cheng JIANG, Shanghai (CN); Zhengjinyang JIANG, Shanghai (CN); Xiuzhuo SHANG, Shanghai (CN); Xiaoting XU, Shanghai (CN); Weimeng HUANG, Shanghai (CN); Tingting LIU, Cambridge (GB)

(21) Appl. No.: 19/139,849

(22) PCT Filed: Jan. 23, 2023
(86) PCT No.: PCT/CN2023/073457

§ 371 Date: Jun. 16, 2025

(51) Int. Cl. H04W 74/0808; H04W 74/08

(52) U.S. Cl. CPC H04W 74/0808; H04W 74/0891

(57) ABSTRACT

Disclosed are systems, apparatuses, processes, and computer-readable media for wireless communications. In one illustrative example, a network device can determine whether a channel map update (CMU) process is ongoing and whether a periodic advertising (PA) event counter of periodic advertising synchronization transfer procedure (PAST) is similar to an instant of the CMU process. The network device can add a current channel map or a channel map of the CMU process to a channel map field of a protocol data unit (PDU) for the PAST based on whether the CMU process is ongoing and/or whether the PA event counter of PAST is similar to the instant of the CMU process.

### FIELD OF THE DISCLOSURE

The present disclosure generally relates to wireless communications. For example, aspects of the present disclosure relate to systems and techniques for optimizing a payload (e.g., a protocol data unit (PDU) payload) for periodic advertising synchronization (e.g., for periodic advertising synchronization transfer procedure (PAST)).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for optimizing a payload (e.g., a PDU payload) for periodic advertising synchronization (e.g., for periodic advertising synchronization transfer procedure (PAST)). By optimizing the payload, the systems and techniques can enhance a success rate of association and resynchronization of a wireless communication device system, such as a peripheral system (e.g., an electronic shelf label (ESL) system).

According to at least one illustrative example, a method of wireless communication performed at a network device is provided. The method includes: determining, by the network device, whether a channel map update (CMU) process is ongoing and whether a periodic advertising (PA) event counter of periodic advertising synchronization transfer procedure (PAST) is similar to an instant of the CMU process; and adding, by the network device, a current channel map or a channel map of the CMU process to a channel map field of a protocol data unit (PDU) for the PAST based on whether at least one of the CMU process is ongoing or whether the PA event counter of PAST is similar to the instant of the CMU process.

In another illustrative example, a network device for wireless communication is provided. The network device includes at least one memory and at least one processor coupled to the at least one memory and configured to: determine whether a channel map update (CMU) process is ongoing and whether a periodic advertising (PA) event counter of periodic advertising synchronization transfer procedure (PAST) is similar to an instant of the CMU process; and add a current channel map or a channel map of the CMU process to a channel map field of a protocol data unit (PDU) for the PAST based on whether at least one of the CMU process is ongoing or whether the PA event counter of PAST is similar to the instant of the CMU process.

In another illustrative example, a non-transitory computer-readable medium is provided having stored thereon instructions that, when executed by at least one processor, cause the at least one processor to: determine whether a channel map update (CMU) process is ongoing and whether a periodic advertising (PA) event counter of periodic advertising synchronization transfer procedure (PAST) is similar to an instant of the CMU process; and add a current channel map or a channel map of the CMU process to a channel map field of a protocol data unit (PDU) for the PAST based on whether at least one of the CMU process is ongoing or whether the PA event counter of PAST is similar to the instant of the CMU process.

In another illustrative example, an apparatus for wireless communications is provided. The apparatus comprises: means for determining whether a channel map update (CMU) process is ongoing and whether a periodic advertising (PA) event counter of periodic advertising synchronization transfer procedure (PAST) is similar to an instant of the CMU process; and means for adding a current channel map or a channel map of the CMU process to a channel map field of a protocol data unit (PDU) for the PAST based on whether at least one of the CMU process is ongoing or whether the PA event counter of PAST is similar to the instant of the CMU process.

In another illustrative example, a method of wireless communication performed at a network device is provided. The method includes: determining, by the network device, whether a channel map update (CMU) process is ongoing; and adding, by the network device, a current channel map to a channel map field of a protocol data unit (PDU) for periodic advertising synchronization transfer procedure (PAST) or appending CMU information to the PDU for the PAST based on whether the CMU process is ongoing.

In another illustrative example, a network device for wireless communication is provided. The network device includes at least one memory and at least one processor coupled to the at least one memory and configured to: determine whether a channel map update (CMU) process is ongoing; and add a current channel map to a channel map field of a protocol data unit (PDU) for periodic advertising synchronization transfer procedure (PAST) or appending CMU information to the PDU for the PAST based on whether the CMU process is ongoing.

In another illustrative example, a non-transitory computer-readable medium is provided having stored thereon instructions that, when executed by at least one processor, cause the at least one processor to: determine whether a channel map update (CMU) process is ongoing; and add a current channel map to a channel map field of a protocol data unit (PDU) for periodic advertising synchronization transfer procedure (PAST) or appending CMU information to the PDU for the PAST based on whether the CMU process is ongoing.

In another illustrative example, an apparatus for wireless communications is provided. The apparatus comprises: means for determining whether a channel map update (CMU) process is ongoing; and means for adding a current channel map to a channel map field of a protocol data unit (PDU) for periodic advertising synchronization transfer procedure (PAST) or appending CMU information to the PDU for the PAST based on whether the CMU process is ongoing.

In another illustrative example, a method of wireless communication performed at a wireless communication device is provided. The method includes: comparing, by the wireless communication device, a local event counter with a periodic advertising (PA) event counter of periodic advertising synchronization transfer procedure (PAST) and an instant of a channel map update (CMU) process; and determining, by the wireless communication device, whether to scan on a channel map of the PAST or scan on a channel map of the CMU process based on comparing the local event counter with the PA event counter and the instant of the CMU process.

In another illustrative example, a wireless communication device for wireless communication is provided. The wireless communication device includes at least one memory and at least one processor coupled to the at least one memory and configured to: compare a local event counter with a periodic advertising (PA) event counter of periodic advertising synchronization transfer procedure (PAST) and an instant of a channel map update (CMU) process; and determine whether to scan on a channel map of the PAST or scan on a channel map of the CMU process based on comparing the local event counter with the PA event counter and the instant of the CMU process.

In another illustrative example, a non-transitory computer-readable medium is provided having stored thereon instructions that, when executed by at least one processor, cause the at least one processor to: compare a local event counter with a periodic advertising (PA) event counter of periodic advertising synchronization transfer procedure (PAST) and an instant of a channel map update (CMU) process; and determine whether to scan on a channel map of the PAST or scan on a channel map of the CMU process based on comparing the local event counter with the PA event counter and the instant of the CMU process.

In another illustrative example, an apparatus for wireless communications is provided. The apparatus comprises: means for comparing a local event counter with a periodic advertising (PA) event counter of periodic advertising synchronization transfer procedure (PAST) and an instant of a channel map update (CMU) process; and means for determining whether to scan on a channel map of the PAST or scan on a channel map of the CMU process based on comparing the local event counter with the PA event counter and the instant of the CMU process.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a signaling diagram illustrating an example of communication transmissions between a network device and two groups of wireless communication devices, in accordance with some aspects of the present disclosure.

FIG. 5 is a timing diagram illustrating an example of communication transmissions where a periodic advertising synchronization transfer procedure (PAST) is being sent during a channel map update (CMU) procedure, in accordance with some aspects of the present disclosure.

FIG. 6A is a diagram illustrating an example of a format for control data of a protocol data unit (PDU) for a PAST, in accordance with some aspects of the present disclosure.

FIG. 6B is a diagram illustrating an example of a format for control data of a PDU for a PAST, where the channel map field of the format of FIG. 6A has been replaced with a CMU indication, in accordance with some aspects of the present disclosure.

FIG. 7 is a flow chart illustrating an example of a process for packaging a PDU at a network device, where the channel map field of the control data may be replaced with a CMU indication, in accordance with some aspects of the present disclosure.

FIG. 8A is a diagram illustrating an example of a format for control data of a PDU for a PAST, in accordance with some aspects of the present disclosure.

FIG. 8B is a diagram illustrating an example of a format for control data of a PDU for a PAST, where CMU information has been appended to the control data, in accordance with some aspects of the present disclosure.

FIG. 9 is a flow chart illustrating an example of a process for packaging a PDU at a network device, where CMU information may be appended to the control data, in accordance with some aspects of the present disclosure.

FIG. 10 is a flow chart illustrating an example of a process for packaging a PDU at a wireless communication device, where CMU information may be appended to the control data, in accordance with some aspects of the present disclosure.

FIG. 11 is a flow chart illustrating an example of a process for wireless communications at a network device, in accordance with some aspects of the present disclosure.

FIG. 12 is a flow chart illustrating an example of a process for wireless communications at a network device, in accordance with some aspects of the present disclosure.

FIG. 13 is a flow chart illustrating an example of a process for wireless communications at a wireless communication device, in accordance with some aspects of the present disclosure.

FIG. 14 is a block diagram illustrating an example of a computing system, which may be employed by the disclosed systems and techniques for optimizing the PDU payload of PAST to enhance the success rate of association and resynchronization of a wireless communication device system, such as an electronic shelf label (ESL) system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, an electronic shelf label (ESL) system may include one or more wireless communication devices (e.g., ESLs) that are controlled by a network entity, such as a management entity (ME), via at least one network device, such as an access point (AP). In one or more examples, to facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. While examples are described herein using ESLs as illustrative examples of wireless communication devices, a management entity as an example of a network entity, and access points as examples of network devices, the systems and techniques described herein are applicable to any type of system or network.

In ESL systems, periodic Advertisements (PAs) are often utilized to provide regular and predictable payload transmissions from a master device (e.g., which may be in the form of a network device, such as an access point) to one or more slave devices (e.g., which may each be in the form of a wireless communication device, such as an ESL or other peripheral device). For example, PAs can be used to issue information from a master device to multiple slave devices, which may be within one or more groups of slave devices. PAs are generally unidirectional (e.g., unidirectional transmissions) such that PAs are transmitted only one-way from a master device to one or more slave devices.

Periodic Advertisement with Response (PAwR) can be used for ESL systems to provide bidirectionality (e.g., bidirectional transmissions between a master device and one or more slave devices). Slave devices synchronized within a group of slave devices can be addressed by a master device on a synchronized channel (e.g., a radio frequency (RF) channel between the master device and the slave devices) whenever the master device chooses to send (e.g., transmit) a request to the slave devices. In some cases, as used herein, a synchronized channel refers to a channel on which transmissions are synchronized (in time). For example, the channel includes a frequency on which one or more communications are transmitted. A hopping frequency sequence defines the channel, where the sequence progresses at a fixed determine interval. A master device and one or more slave devices can concurrently track the sequence at a predefined frequency hopping pattern or sequence (e.g., so the master device knows when to transmit the request and the slave devices know when to listen for and/or receive the request).

A request transmitted by a master device to slave devices in a particular group may be a PA containing a synchronization message transmitted by the master device on the synchronized channel to the slave devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the master device and the slave devices in the group is based on the periodicity of the PA. The periodically-transmitted messages (e.g., the synchronization messages) include zero, one, or more commands (e.g., a respective operational code (OpCode) and parameters associated with each command). If a response from a slave device is expected by the master device (e.g., the synchronization message from the master device requests a response from a specific slave device), the particular slave device will respond in a specific response slot, based on where the slave device appeared within a sequence contained within the synchronization message transmitted by the master device.

Each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

Periodic advertising synchronization transfer procedure (PAST) provides a method to establish synchronization between a master device (e.g., a network device, such as an access point) and slave devices (e.g., wireless communication devices, such as ESLs). For example, PAST provides a method for a master device to send synchronization information about a PA train over an existing connection to slave devices. A slave device can establish PA synchronization with the master device by using the synchronization information it receives from the master device. Currently, there are two types of protocol data units (PDUs) for PAST. A first type of PDU for PAST is LL_PERIODIC_SYNC_IND (e.g., a link layer periodic synchronization indication). A second type of PDU for PAST is LL_PERIODIC_SYNC_WR_IND for PAWR (e.g., a link layer periodic synchronization with response indication). PAST may be used to establish the PA synchronization between a master device and slave devices for two different scenarios. One scenario may be an association scenario where a slave device may transition from an unassociated state to a synchronized state. Another scenario may be a resynchronization scenario where a slave device may be resynchronized after it has lost synchronization with the master device.

In some cases, during operation of a slave device-based system (e.g., with one or more master devices and peripheral devices, such as an ESL system including one or more APs in communication with group(s) of ESLs), PAST may occur (e.g., be transmitted) during (e.g., in the middle of) a CMU process. In such cases, the channel map of the PAST (e.g., the old channel map) will be the channel map that the PA train (or PAwR train) is currently using. Conversely, the channel map of the CMU (e.g., the new channel map) will be the future channel map that the PA train (or PAwR) will switch to use in the future (e.g., use at an instant defined at a future time). A slave device will use the old channel map to scan for (e.g., listen to) the PA synchronization packets (e.g., AUX_SYNC_IND) transmitted from a master device. However, the master device will switch from using the old channel map to using the new channel map for its transmissions. Unfortunately, the slave device will not be aware of this switching to the new channel map and will continue to try to scan (e.g., try to listen) using the old channel map. Since the slave device is unaware of the need to switch to the new channel map, by continuing to use the old channel map, the slave device will fail to synchronize or re-synchronize with the master device.

Once the association or synchronization is lost, the slave device may then perform an onboarding procedure to reestablish synchronization with the master device. The onboarding procedure may consume significant computing resources (e.g., processor resources, memory resources, and/or battery resources, among other examples) of the slave device and/or the master device, and frequent advertisement by one or more slave devices may result in spectral pollution on advertisement channels of the wireless network.

Systems and techniques are described herein for optimizing a payload for periodic advertising synchronization. For example, according to some aspects, the systems and techniques can optimize a PDU payload of PAST. The systems and techniques amend the format of the PDU payload for PAST to allow for the slave devices to switch to using the updated channel map (e.g., the new channel map) when the master device has switched to using the updated channel map for its transmissions. In one or more examples, a channel map field (e.g., containing the current or old channel map) of the PDU for PAST is replaced with the CMU indication (e.g., an indication of the updated or new channel map). In some examples, CMU information is appended to the PDU for PAST to make the slave devices aware that the master device is performing a CMU procedure, and the slave devices can then determine if and when they will need to switch to the updated channel map to scan for the master device's transmissions. While examples are described herein using ESLs as illustrative examples of wireless communication devices, a management entity as an example of a network entity, and access points as examples of network devices, the systems and techniques described herein are applicable to any type of system or network.

The systems and techniques described herein provide various advantages. For example, an advantage of the systems and techniques includes enhancing the success rate of association and resynchronization of a wireless communication device system (e.g., an ESL system) based on optimizing payloads for periodic advertising synchronization (e.g., PDU payloads for PAST) in the system. Such a solution can prevent a slave device (e.g., a peripheral device such as an ESL) from failing to associate or synchronize (or in some cases from being disassociated) with a master device, removing the need for the slave device to perform an onboarding procedure to reestablish synchronization with the master device. By avoiding the onboarding process to re-associate or re-synchronize with the master device, the slave device can avoid the need to consume additional consumption of computing resources (e.g., processor resources, memory resources, and/or battery resources, etc.) that are needed to perform the onboarding procedure. Such a solution also reduces or prevents spectral pollution on advertisement channels of the wireless network.

While aspects described herein relate to establishment of PA synchronization between ESLs and one or more access points for illustrative and explanatory purposes, the systems and techniques described herein apply to establishment of any general PA synchronization.

Additional aspects of the present disclosure are described in more detail below.

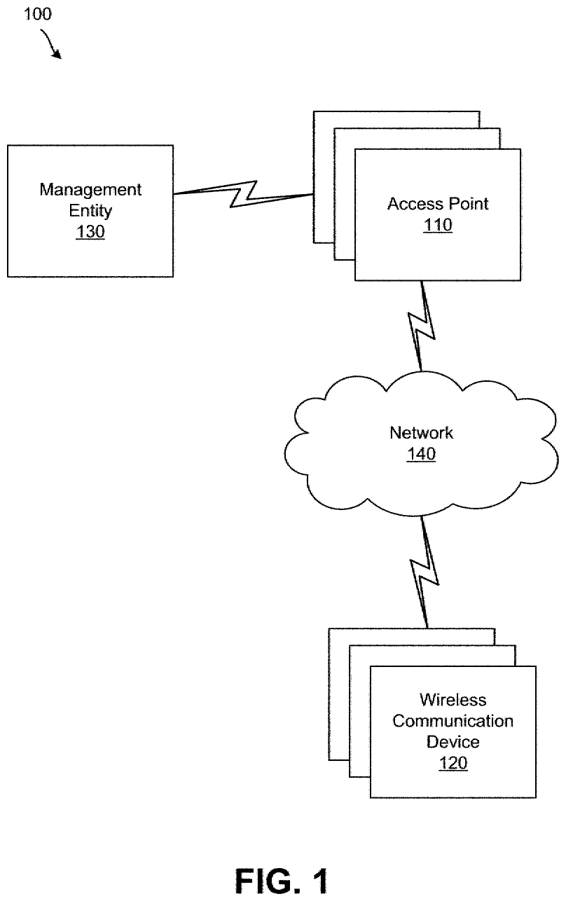

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

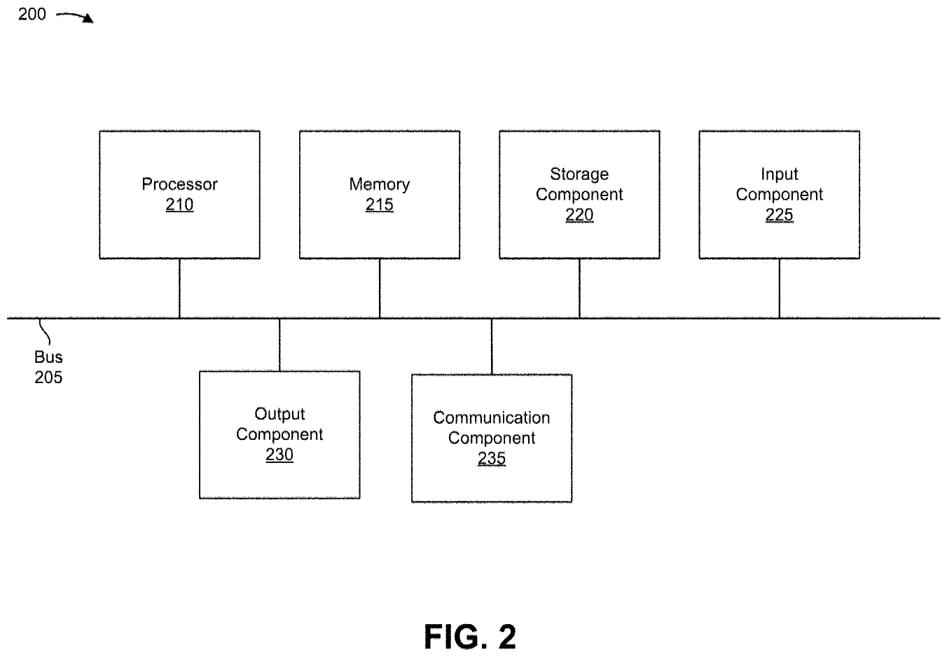

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device chooses to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

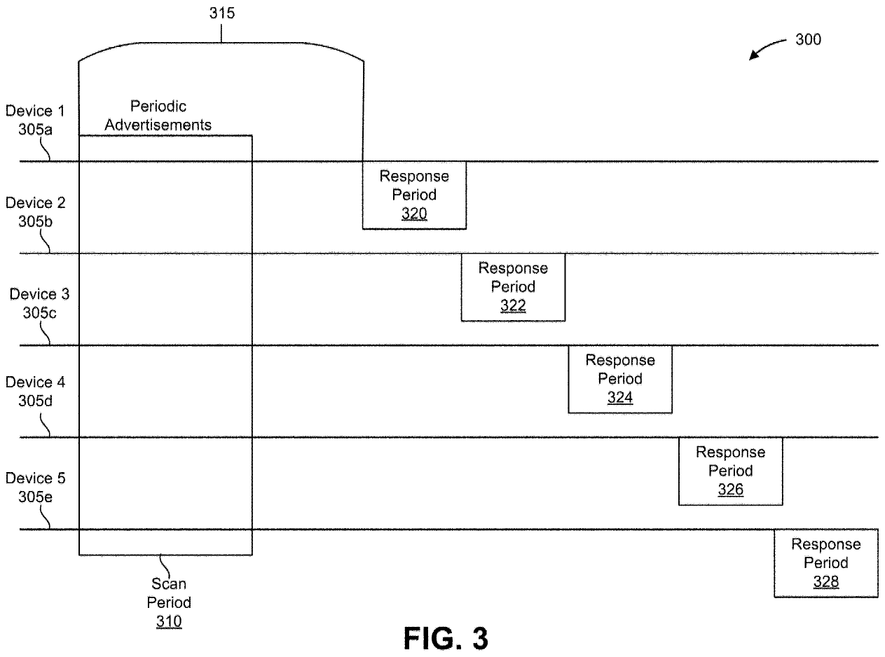

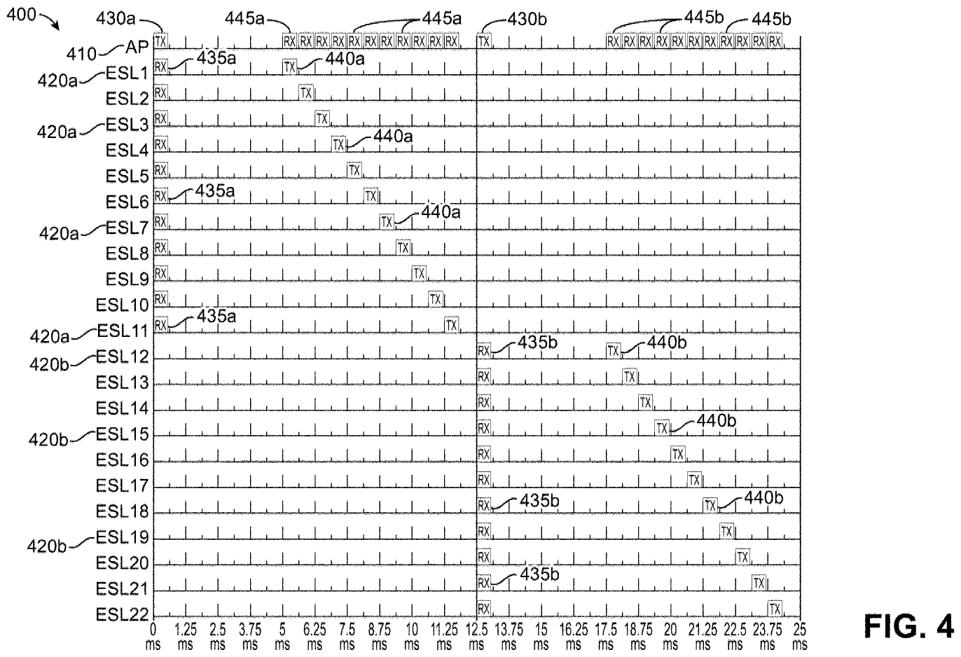

FIGS. 3 and 4 show signaling diagrams illustrating examples of PAwR in an ESL system. In particular, the signaling diagram of FIG. 3 shows an example PAwR for a group of wireless network devices (e.g., device 1 305a, device 2 305b, device 3 305c, device 4 305d, and device 5 305e), and the signaling diagram of FIG. 4 shows an example PAwR for two groups of wireless network devices 420a, 420b (e.g., a first group including ESL1 to ESL 11, and a second group including ESL 12 to ESL 22). Specifically, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, FIG. 4 shows an example PAwR for two groups of wireless network devices 420a, 420b (e.g., a first group including ESL1 to ESL 11, and a second group including ESL 12 to ESL 22). In particular, FIG. 4 is a signaling diagram illustrating an example of communication transmissions 400 between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective response slot in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective time slots, the network device 410 can receive 445a their transmitted responses at those specific response slot times.

Then, during operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12,ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective time slots, the network device 410 can receive 445b their transmitted responses at those specific response slot times. Then, the PAwR may continue similarly for subsequent subframes of time.

As previously noted, each access point (e.g., master device) may have an associated channel map. A channel map is a listing of frequency channels to be utilized or, conversely, not to be utilized (e.g., in the context of modification of frequency hopping sequences) by an access point for communication, such as with the ESLs or other devices. The channel map of an access point can be updated via a channel map update (CMU). A CMU is a procedure for updating (or changing) a current channel map (ChM) for an access point to a new channel map for the access point. During a CMU, an access point can transmit synchronization messages, which can include information associated with the CMU (e.g., in an ACAD field of each synchronization message), to the ESLs. The CMU information in the synchronization messages notify the ESLs of the new channel map to be used for future communications with the access point.

In an ESL system, an access point (e.g., master device) may transmit synchronization messages carried in an AUX_SYNC_IND (e.g., an auxiliary synchronization indication) on periodic physical channels. In some cases, to coexist with a wireless local area network (WLAN) or to avoid noisy channels, the access point (e.g., master device) may need to change the channel map. The access point (e.g., master device) may change the channel map by performing a CMU by using a CMU indication, which can be carried in the ACAD field of AUX_SYNC_IND. AUX_SYNC_IND may contain a channel map (ChM) field, which contains the future channel map (e.g., the new channel map) the PA train will switch to, and an Instant field, which is a future time (e.g., for a PeriodicEventCounter, which is the event counter for a PA train) that the access point will switch to using the future channel map (e.g., the new channel map). To ensure that an ESL (e.g., slave device) can receive the CMU information successfully, the access point (e.g., master device) can sends the AUX_SYNC_IND+CMU at least a certain number of times (e.g., at least six (6) times) per each group of ESLs (e.g., 6*128 groups of ESLs for PAwR).

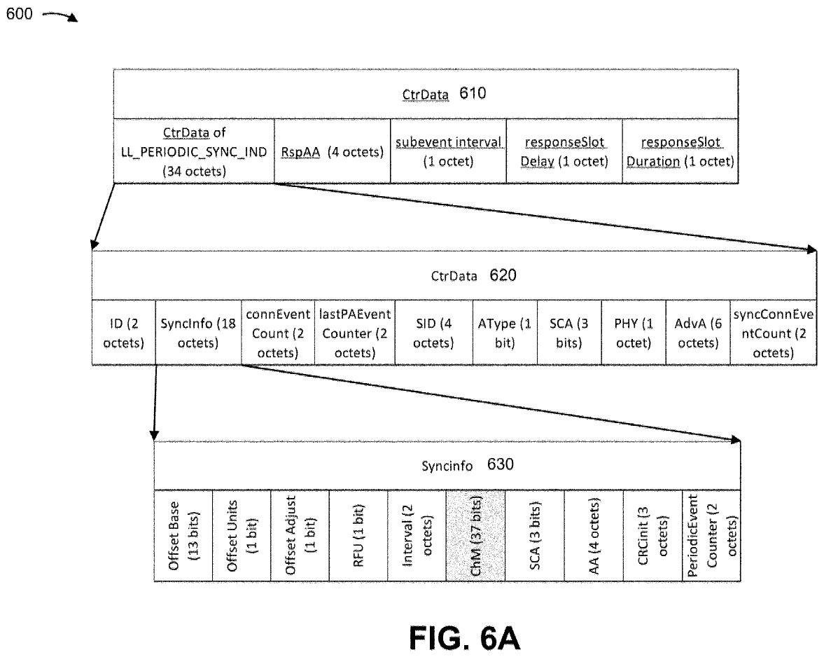

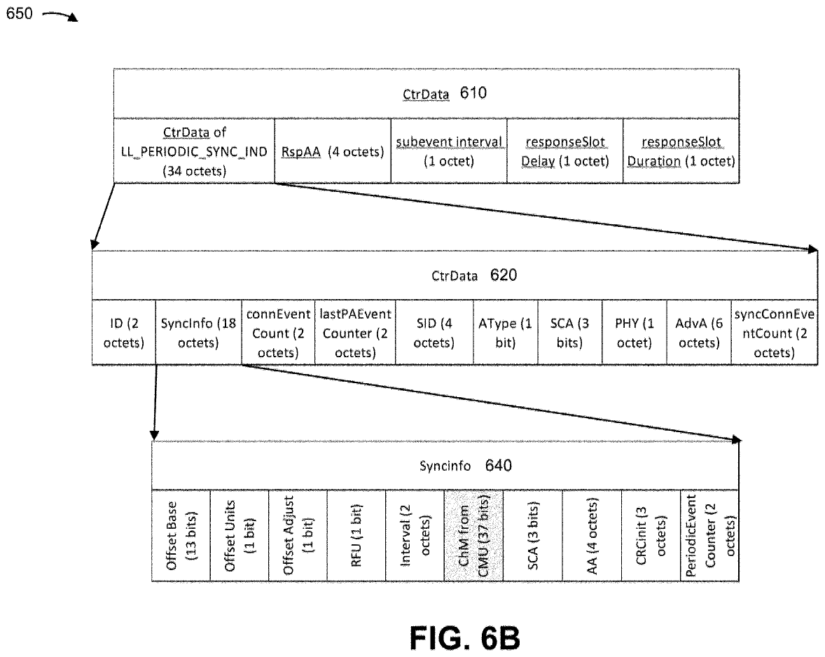

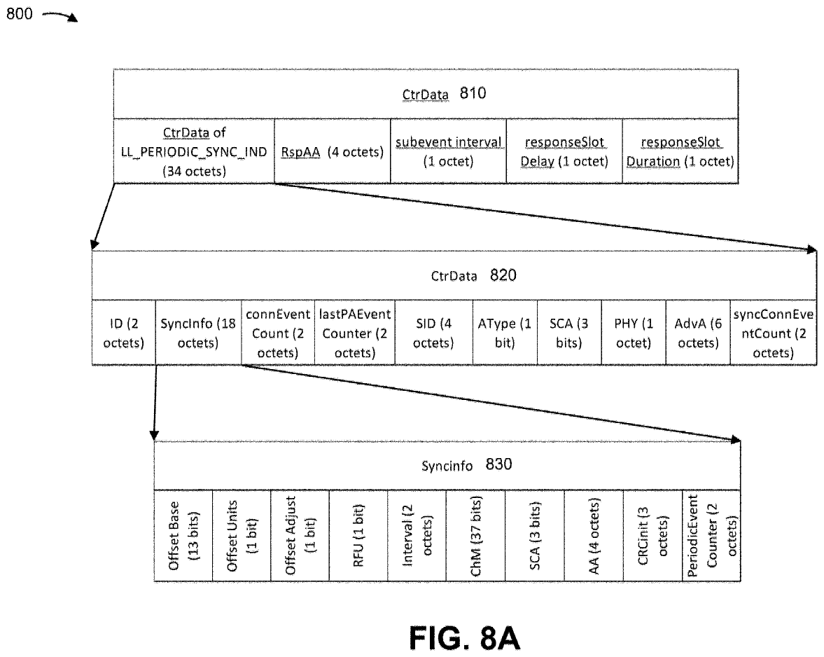

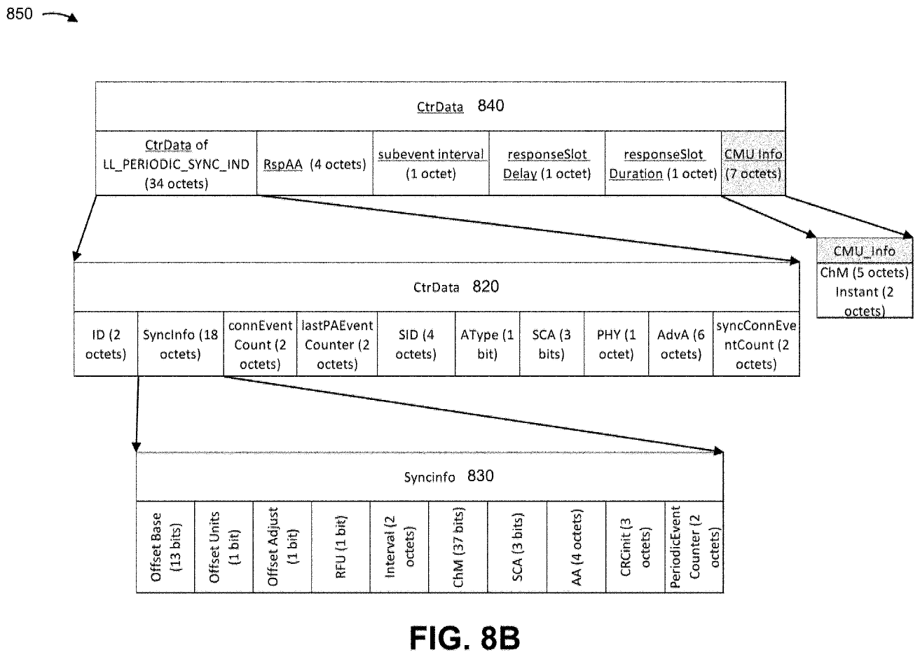

Periodic advertising synchronization transfer procedure (PAST) provides a method to establish synchronization between a master device (e.g., a network device, such as an access point) and slave devices (e.g., wireless communication devices, such as ESLs). In particular, PAST provides a method for a master device to send synchronization information about a PA train over an existing connection to slave devices. A slave device may establish PA synchronization with the master device by using the synchronization information it receives from the master device. Currently, there are two types of protocol data units (PDUs) for PAST. A first type of PDU for PAST is LL_PERIODIC_SYNC_IND (e.g., a link layer periodic synchronization indication), and a second type of PDU for PAST is LL_PERIODIC_SYNC_WR_IND for PAWR (e.g., a link layer periodic synchronization with response indication). PAST can be used to establish the PA synchronization between a master device and slave devices for two different scenarios. One scenario may be an association scenario where a slave device may transition from an unassociated state to a synchronized state. Another scenario may be a resynchronization scenario where a slave device may be resynchronized after it has lost synchronization with the master device. Currently, ESL systems employ PAWR, of which PAST can use the LL_PERIODIC_SYNC_WR_IND PDU to send synchronization information to the ESLs. The format for LL_PERIODIC_SYNC_WR_IND PDU is shown in FIGS. 6A and 8A.

In some cases, during operation of an ESL system, PAST may occur (e.g., be transmitted) during (e.g., in the middle of) a CMU process. For example, since for an ESL system, a CMU process will typically require a large amount of time (e.g., for 6*128 groups of ESLs, the CMU process can take up to 9.6 seconds to complete), PAST may be sent in the middle of a lengthy CMU process. The channel map of the PAST (e.g., the old channel map) will be the channel map that the PA train is currently using. Conversely, the channel map of the CMU (e.g., the new channel map) will be the future channel map that the PA train will switch to use in the future (e.g., use at an instant defined at a future time). The slave device will use the old channel map to scan for (e.g., listen to) the PA synchronization packets (e.g., AUX_SYNC_IND) transmitted from the master device. However, the master device will soon switch from using the old channel map to using the new channel map for its transmissions. Unfortunately, the slave device will not be aware of this switching to the new channel map and will simply continue to try to scan (e.g., try to listen) using the old channel map. Since the slave device is unaware of the need to switch to the new channel map, by continuing to use the old channel map, the slave device will fail to associate with the master device.

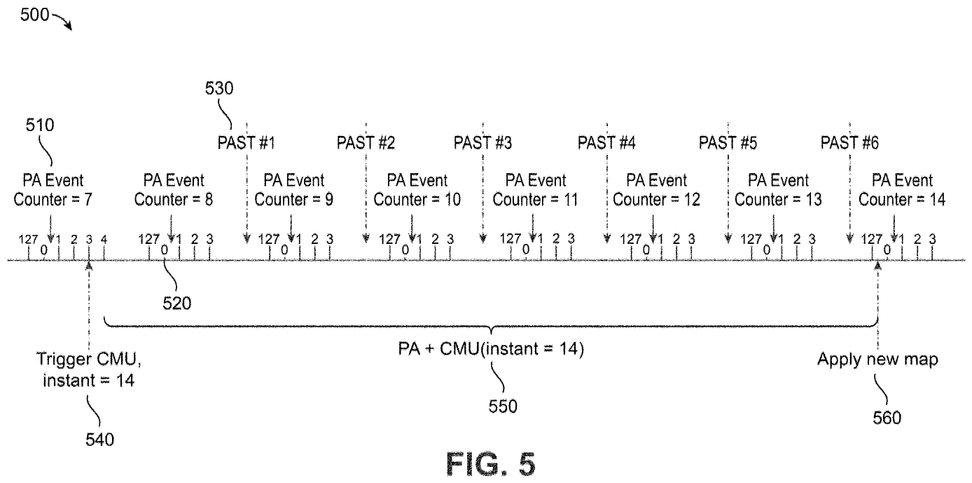

FIG. 5 illustrates PAST being sent during a CMU procedure. In particular, FIG. 5 is a timing diagram illustrating an example of communication transmissions 500 where PAST 530 (e.g., PAST 1, PAST 2, PAST 4, PAST 4, PAST 5, and PAST 6) is being sent during a CMU process 550. In FIG. 5, time is represented along the x-axis of the timing diagram. A PA train (e.g., including a plurality of transmissions 520 from a master device, such as an access point, to 128 groups of ESLs) over multiple PA intervals is shown. Also shown is a PA EventCounter 510 for the PA train. The PA EventCounter 510 can be incremented by one for each PA interval. As such, in FIG. 5, for the first PA interval shown, the PA EventCounter 510 is shown to equal seven; for the second PA interval shown, the PA EventCounter 510 is shown to equal eight; etc. A SubEventCounter can be incremented by one for each transmission 520 of each group.

In FIG. 5, a CMU process 550 is shown to start 540 when the PA EventCounter is equal to seven, at the triggering of the CMU process 550, and end 560 when the PA EventCounter is equal to thirteen. The CMU information can indicate to a slave device (e.g., wireless communication device 120 of FIG. 1 or ESL 420a, 420b of FIG. 4) that a master device (e.g., an access point, such as access point 110 of FIG. 1 or access point 410 of FIG. 4) will switch to a new channel map for transmissions of the PA train at an instant (e.g., a specific time, such as when the PA EventCounter is equal to fourteen).

A PAST transmission (e.g., PAST transmission 530) can be transmitted by a master device (e.g., an access point) when the master device wants to onboard or resynchronize a slave device (e.g., ESL). The PAST transmissions may be transmitted randomly by the master device (e.g., access point). As noted previously, PAST can be used to establish synchronization between a master device (e.g., a network device, such as an access point) and slave devices (e.g., ESLs). For example, PAST can be used to establish PA synchronization. After receiving the PAST 530 packet (e.g., a PAST PDU), the slave device can attempt to listen to PA packets (e.g., AUX_SYNC_IND) in six PA intervals. If a slave device receives at least one PA packet (AUX_SYNC_IND) during the six PA intervals, synchronization is successfully established.

When a PAST transmission is sent during a CMU process 550 (e.g., between PA EventCounter 7 to 13), the channel map of the PAST is older than that of the CMU. As such, the channel map of the PAST transmission (e.g., the old channel map) will be the channel map that the PA train is currently using, and the channel map of the CMU (e.g., the new channel map) will be the future channel map that the PA train will switch to use in the future (e.g., use at an instant defined at a specific future time). PAST transmissions sent after a CMU process 550 has completed will contain the channel map of the CMU (e.g., the new channel map).

If a PAST transmission is sent (e.g., transmitted) during a CMU process 550 at a particular position (e.g., at position PAST #6 shown in FIG. 5), a slave device (e.g., ESL) may not receive the channel map of the CMU (e.g., the new channel map). As such, the slave device (e.g., ESL) will use the old channel map (e.g., which the slave device received from the PAST 530) to scan for (e.g., listen to) the PA synchronization packets transmitted from the master device (e.g., access point). For example, if a PAST transmission is sent at the position denoted as PAST #6 in FIG. 5 during the CMU process, then a target slave device (e.g., target ESL) will scan for (e.g., listen for) a PA packet according to the old channel map of PAST; however, in such an example, the AP has switched to the channel map of the CMU. Because the slave device is listening on the wrong channel (specified by the old channel map) at the position PAST #6, the target slave device will have a very low chance of receiving PA packets of the PA train. However, for positions PAST #1 through PAST #5, the target slave device (e.g., target ESL) will have several chances to receive the PA packets of the PA train because the channel map switch has not yet occurred. The number of chances for the target slave device to receive the PA packets is based on the particular PAST position of the CMU (e.g., for PAST #1 there are 5 chances, for PAST #2 there are 4 chances, and so on).

When the PA EventCounter equals the instant (e.g., fourteen), the master device (e.g., access point) will switch to the using the channel map of the CMU (e.g., the new channel map) for its transmissions. However, the slave device (e.g., ESL) can only receive the PAST 530 information (e.g., including the old channel map). As such, the slave device (e.g., ESL) will scan (e.g., listen to) the PA synchronization packets using the old channel map to establish the PA synchronization. The slave device (e.g., ESL) will have no chance to successfully scan the PA synchronization packets because, after the instant, the master device (e.g., access point) will transmit the PA synchronization packets on the channel map of the CMU (e.g., the new channel map), not the old channel map, which is what the slave device (e.g., ESL) is using the scan. Therefore, the slave device (e.g., ESL) will not be able to successfully associate or resynchronize with the master device (e.g., access point).

As previously mentioned, the systems and techniques optimize the PDU payload of PAST to enhance the success rate of association and resynchronization of a wireless communication device system, such as an ESL system. The systems and techniques can amend the format of the PDU payload for PAST to allow for the slave devices to switch to using the updated channel map (e.g., the new channel map) when the master device has switched to using the updated channel map for its transmissions. In one or more examples, a channel map field (e.g., containing the current or old channel map) of the PDU for PAST can be replaced with the CMU indication (e.g., an indication of the updated or new channel map).

FIGS. 6A and 6B together illustrate how the channel map (ChM) field (e.g., an indication of the old channel map) of the PDU payload for PAST is replaced with the CMU indication (e.g., an indication of the updated or new channel map). Replacing the channel map field (ChM) of the PDU payload for PAST with the CMU indication can be used for cases when the PA EventCounter for PAST (e.g., PAST 6 530 of FIG. 5) is equal to the instant of the CMU. In particular, FIG. 6A is a diagram illustrating an example of a format for control data of a protocol data unit (PDU) for a PAST. In FIG. 6A, the format for control data (CtrData) 610 of PDU for PAST is shown. The CtrData 610 is shown to include five fields, which may include a control data of LL_PERIODIC_SYNC_IND field, a RspAA field, a subevent interval field, a responseSlot Delay field, and a responseSlot Duration field.

Control data 620 for the control data of LL_PERIODIC_SYNC_IND field is shown to include ten fields, which may include an ID field, a SyncInfo field, a connEventCount field, a lastPAEventCounter field, a SID field, an AType field, a SCA field, a PHY field, an AdvA field, and a syncConnEve field.

Syncinfo 630 for the SyncInfo field is shown to include ten fields, which may include an Offset Base field, an Offset Units field, an Offset Adjust field, an RFU field, an Interval field, a ChM field, a SCA field, an AA field, a CRCInit field, and a PeriodicEventCounter field.

The channel map (ChM) field of the Syncinfo 630 contains the current channel map (e.g., an indication of the old channel map). The PeriodicEventCounter field of the Syncinfo 630 contains the event counter for a PA train. Each PA train can have a 16-bit event counter, which can be incremented by one for each PA interval.

FIG. 6B is a diagram illustrating an example of a format 650 for control data of a PDU for a PAST, where the channel map field of the format of FIG. 6A has been replaced with a CMU indication. In particular, the Syncinfo 640 of FIG. 6B is similar to the Syncinfo 630 of FIG. 6A, except that the channel field (ChM) field (e.g., an indication of the old channel map) of the Syncinfo 630 of FIG. 6A has been replaced by a channel map (ChM) from the CMU indication (e.g., an indication of the updated or new channel map) for the Syncinfo 640 of FIG. 6B.

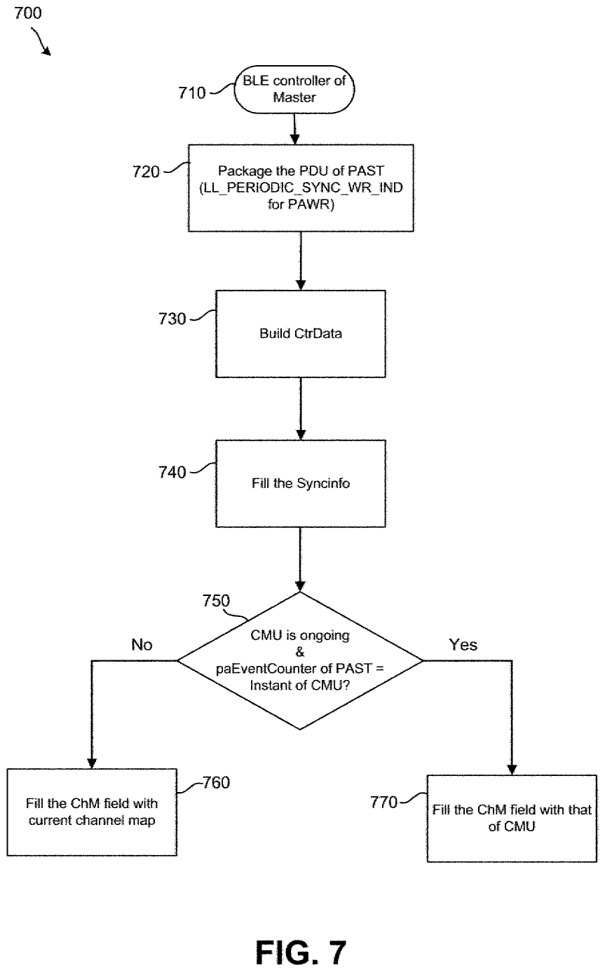

FIG. 7 shows an example of a process 700 for replacing the channel map (ChM) field of the PDU for PAST with that of a CMU indication. In particular, FIG. 7 is a flow chart illustrating an example of a process 700 for packaging a PDU at a network device (e.g., a master device, such as an access point), where the channel map field of the control data may be replaced with a CMU indication. In FIG. 7, the process 700 can be performed by the BLE controller of the master device 710. At block 720 of the process 700, the master device may package the PDU of PAST (e.g., LL_PERIODIC_SYNC_WR_IND for PAwR). At block 730, the master device may build the control data (CtrData). At block 740, the master device can fill the Syncinfo.

At decision block 750, the master device can determine whether or not the CMU is ongoing (e.g., process) and the PA EventCounter of PAST is similar to (e.g., equal to) the instant of the CMU. For example, the master device can receive a communication (e.g., a packet) with a flag that indicates the CMU is ongoing (or in process). If the master device determines that the CMU is not ongoing and/or the PA EventCounter of PAST is not similar to (e.g., not equal to) the instant of the CMU, at block 760, the master device can fill the ChM field with the current channel map (e.g., the old channel map), as is shown in the format 600 of FIG. 6A. However, if the master device determines that the CMU is ongoing and the PA EventCounter of PAST is similar to (e.g., equal to) the instant of the CMU, at block 770, the master device can fill the ChM field with that of the CMU, as is shown in the format 650 of FIG. 6B.

As previously mentioned, the systems and techniques can optimize the PDU payload of PAST to enhance the success rate of association and resynchronization of a wireless communication device system, such as an ESL system. For example, the systems and techniques can amend the format of the PDU payload for PAST to allow for the slave devices to switch to using the updated channel map (e.g., the new channel map) when the master device has switched to using the updated channel map for its transmissions. In one or more examples, CMU information can be appended to the PDU for PAST (e.g., for PAwR, the PDU is LL_PERIODIC_SYNC_WR_IND) to make the slave devices aware that the master device is performing a CMU procedure, and the slave devices can then determine if and when they will need to switch to the updated channel map to scan for the master device's transmissions. For example, the slave devices may compare the PA EventCounter of the original PAST with the instant of the CMU indication to determine if and when they will need to switch to the updated channel map.

FIGS. 8A and 8B together illustrate how the CMU information can be appended to the PDU for PAST. In particular, FIG. 8A is a diagram illustrating an example of a format 800 for control data of a PDU for a PAST. The format 800 of FIG. 8A is similar to the format 600 of FIG. 6A.

In FIG. 8A, the format for control data (CtrData) 810 of PDU for PAST is shown. The CtrData 810 is shown to include five fields, which may include a control data of LL_PERIODIC_SYNC_IND field, a RspAA field, a subevent interval field, a responseSlot Delay field, and a responseSlot Duration field.

Control data 820 for the control data of LL_PERIODIC_SYNC_IND field is shown to include ten fields, which may include an ID field, a SyncInfo field, a connEventCount field, a lastPAEventCounter field, a SID field, an AType field, a SCA field, a PHY field, an AdvA field, and a syncConnEve field.

Syncinfo 830 for the SyncInfo field is shown to include ten fields, which may include an Offset Base field, an Offset Units field, an Offset Adjust field, an RFU field, an Interval field, a ChM field, a SCA field, an AA field, a CRCInit field, and a PeriodicEventCounter field.

FIG. 8B is a diagram illustrating an example of a format 850 for control data of a PDU for a PAST, where CMU information has been appended to the control data. In particular, the CtrData 840 of FIG. 8B is similar to the CtrData 810 of FIG. 8A, except that the CtrData 840 of FIG. 8B additionally includes the CMU info, which may include the channel map (ChM) for the CMU and the instant for the CMU.

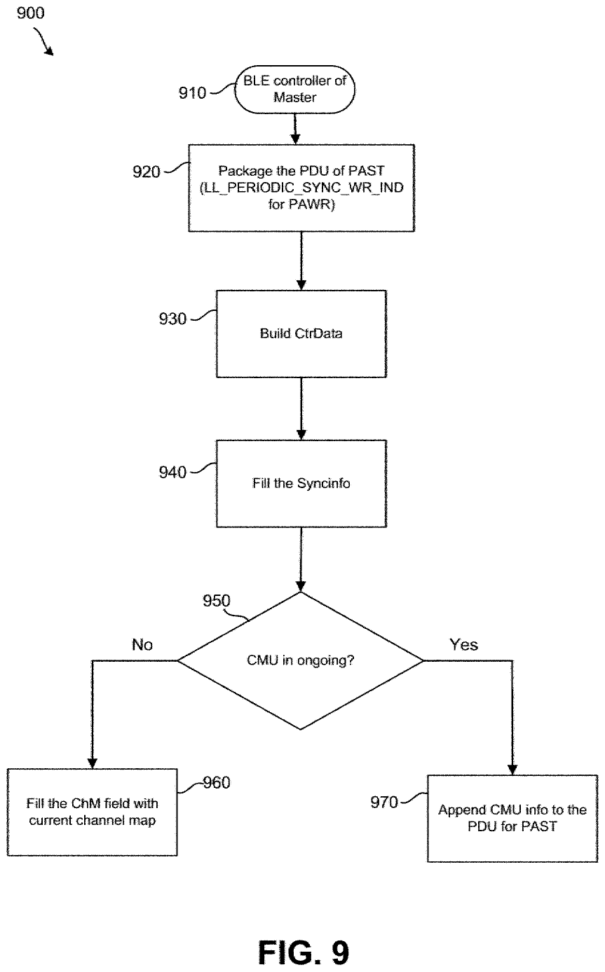

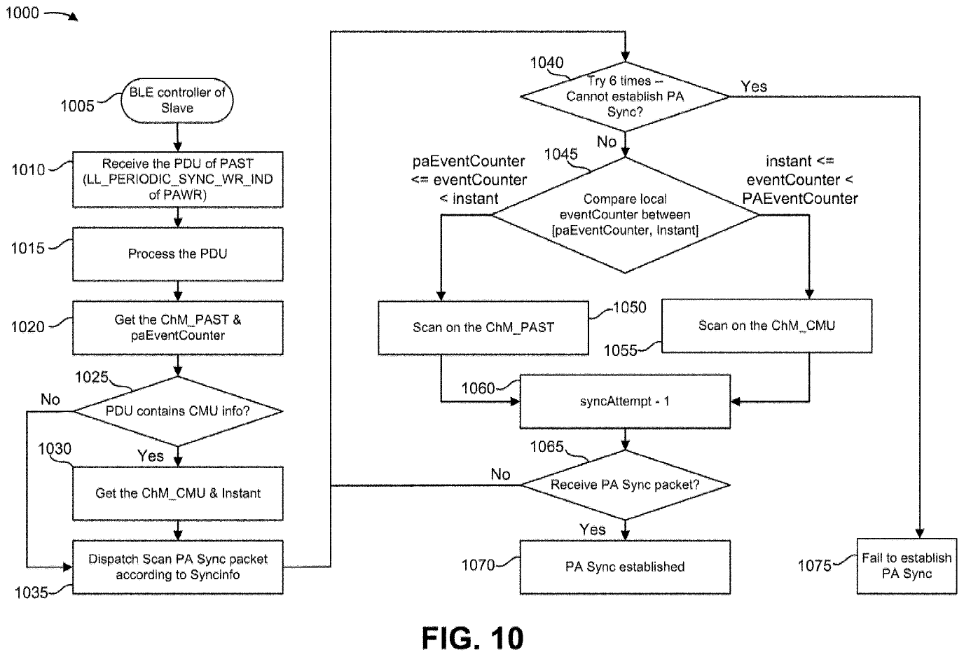

FIGS. 9 and 10 show examples of processes 900, 1000 for appending CMU information to the PDU for PAST. In particular, FIG. 9 is a flow chart illustrating an example of a process 900 for packaging a PDU at a network device (e.g., a master device, such as an access point), where CMU information may be appended to the control data. In FIG. 9, the process 900 may be performed by the BLE controller of the master device 910. At block 920 of the process 900, the master device may package the PDU of PAST (e.g., LL_PERIODIC_SYNC_WR_IND for PAwR). At block 930, the master device may build the control data (CtrData). At block 940, the master device can fill the Syncinfo.

At decision block 950, the master device can determine whether or not the CMU is ongoing. If the master device determines that the CMU is not ongoing, at block 960, the master device can fill the ChM field with the current channel map (e.g., the old channel map), as is shown in the format 800 of FIG. 8A. However, if the master device determines that the CMU is ongoing, at block 970, the master device can append the CMU information to the PDU for PAST, as is shown in the format 850 of FIG. 8B.

FIG. 10 is a flow chart illustrating an example of a process 1000 for packaging a PDU at a wireless communication device (e.g., a slave device, such as an ESL), where CMU information may be appended to the control data. In FIG. 10, the process 1000 may be performed by a controller (e.g., a BLE controller) of the slave device 1005. At block 1010, the slave device receive the PDU of PAST (e.g., LL_PERIODIC_SYNC_WR_IND for PAwR), such as from a master device. At block 1015, the slave device can process the PDU. At block 1020, the slave device can obtain the ChM_PAST (e.g., the PAST channel map) and PA EventCounter (PA event counter).

At decision block 1020, the slave device can determine whether the PDU contains CMU information. If the slave devices determines that the PDU does contain CMU information, at block 1030, the slave device can obtain the ChM_CMU (e.g., the CMU channel map) and the instant (e.g., for the CMU). However, if the slave device determines that the PDU does not contain CMU information, the process 1000 proceeds to block 1035, where the slave device can dispatch a Scan PA Sync packet according to the Syncinfo.

At decision block 1040, the slave device can try a certain number of times (e.g., six times) to establish PA Synch (e.g., PA synchronization) with the master device. The slave device can determine whether the slave device was able or unable to establish PA Sync after the number of times (e.g., after the six attempts). If the slave device determines that the slave device was unable to establish PA Sync, at block 1075, the slave device failed to establish PA Sync.

However, if the slave device determines that the slave device was able to establish PA Sync, at decision block 1045, the slave device can compare the local eventCounter (e.g., local event counter) with the PA EventCounter and the Instant. If the slave device determines that the PA EventCounter is less than or equal to the local eventCounter, and the local eventCounter is less than the Instant, then at block 1050, the slave device can scan on the ChM_PAST (e.g., scan using the PAST channel map). However, if the slave device determines that the Instant is less than or equal to the local eventCounter, and the local eventCounter is less than the PA EventCounter, then at block 1055, the slave device can scan on the ChM_CMU (e.g., scan using the CMU channel map).

At block 1060, the slave device can make a syncAttempt (e.g., attempt synchronization with the master device). At decision block 1065, the slave device can determine whether PA Sync is established with the master device. If the slave device determines that PA Sync is not established, the process 1000 proceeds back to decision block 1040.

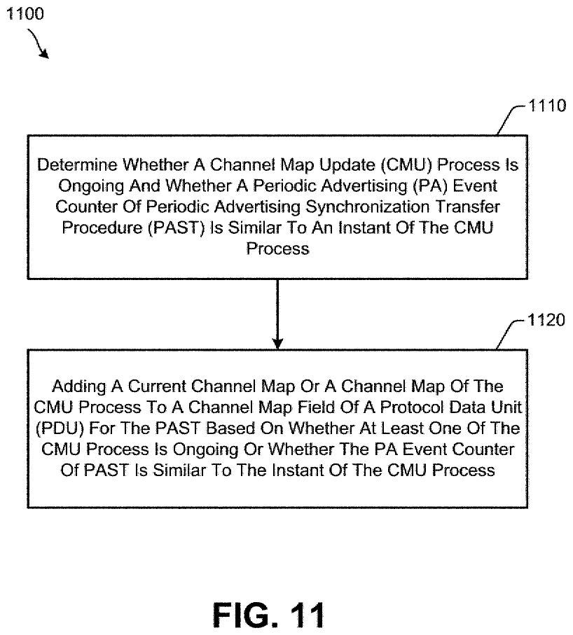

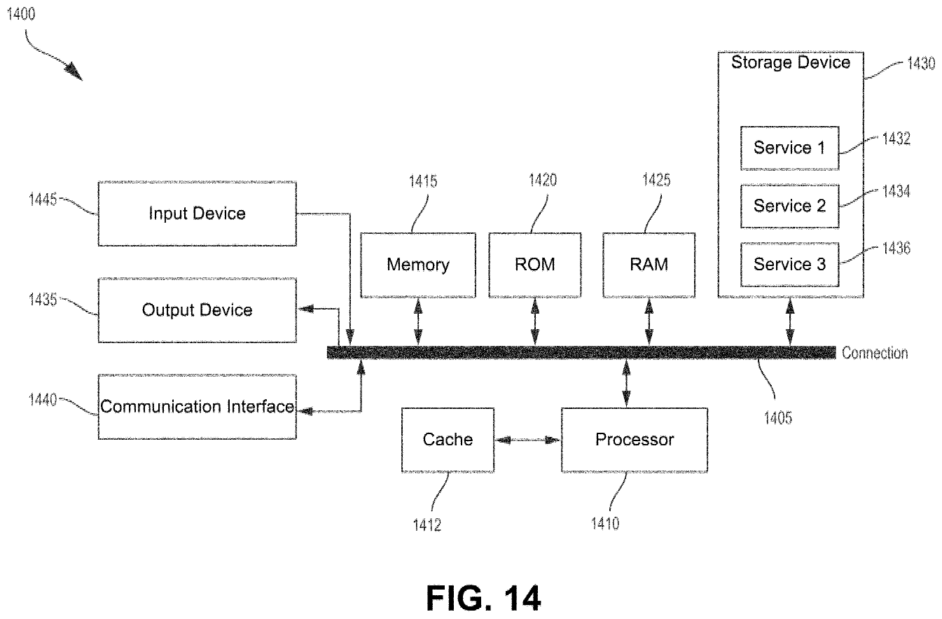

FIG. 11 is a flow chart illustrating an example of a process 1100 for wireless communications utilizing methods for optimizing the PDU payload of PAST to enhance the success rate of association and resynchronization of a wireless communication device system (e.g., an ESL system). The process 1100 can be performed by a network device, such as a master device (e.g., an AP, such as the AP 110 of FIG. 1 and/or the AP 410 of FIG. 4), or by a component or system (e.g., a chipset) of the network device. The operations of the process 1100 may be implemented as software components that are executed and run on one or more processors (e.g., processor 1410 of FIG. 14 or other processor(s)). Further, the transmission and reception of signals by the network device in the process 1100 may be enabled, for example, by one or more antennas and/or one or more transceivers such as one or more wireless transceiver(s) (e.g., communication interface 1440 of FIG. 14).

At block 1110, the network device (or component thereof) can determine whether a channel map update (CMU) process is ongoing and whether a periodic advertising (PA) event counter of periodic advertising synchronization transfer procedure (PAST) is similar to an instant of the CMU process. For example, the master device can receive a communication (e.g., a packet) with a flag that indicates the CMU is ongoing (or in process). In some cases, the PAST is transmitted during the CMU process. In some aspects, the instant of the CMU process is a time when the channel map of the CMU process is used by the network device for transmissions. In some examples, to determine whether the PA event counter of PAST is similar to the instant of the CMU process, the network device (or component thereof) can determine whether the PA event counter of PAST is equal to the instant of the CMU process.

At block 1120, the network device (or component thereof) can add a current channel map or a channel map of the CMU process to a channel map field of a protocol data unit (PDU) for the PAST based on whether the CMU process is ongoing and/or whether the PA event counter of PAST is similar to the instant of the CMU process. In one illustrative example, to add the current channel map or the channel map of the CMU process to the channel map field of the PDU for the PAST, the network device (or component thereof) can add the current channel map to the channel map field of the PDU for the PAST based on determining that the CMU process is not ongoing and/or the PA event counter of PAST is not similar to the instant of the CMU process. For instance, as described previously with respect to FIG. 7, if the network device (e.g., master device) determines that a CMU process is not ongoing and/or the PA event counter (e.g., PA EventCounter) of PAST is not similar to (e.g., not equal to) the instant of the CMU, the network device can fill the channel map field (e.g., ChM field) of the PDU with the current channel map, as shown in the format 600 of FIG. 6A. In another illustrative example, to add the current channel map or the channel map of the CMU process to the channel map field of the PDU for the PAST, the network device (or component thereof) can add the channel map of the CMU process to the channel map field of the PDU for the PAST based on determining the CMU process is ongoing and the PA event counter of the PAST is similar to the instant of the CMU process. For instance, if the network device determines that the CMU is ongoing and the PA event counter of PAST is similar to (e.g., equal to) the instant of the CMU, the network device can fill the channel map field (e.g., ChM field) with that of the CMU, as shown in the format 650 of FIG. 6B.

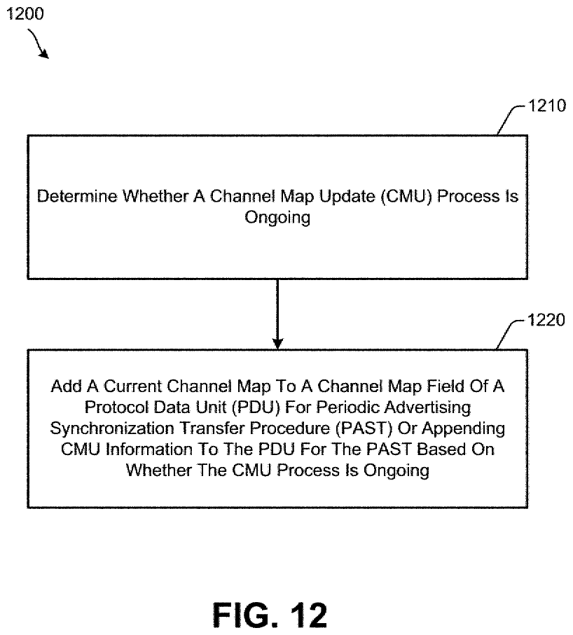

FIG. 12 is a flow chart illustrating an example of a process 1200 for wireless communications utilizing methods for optimizing the PDU payload of PAST to enhance the success rate of association and resynchronization of a wireless communication device system (e.g., an ESL system). The process 1200 can be performed by a network device, such as a master device (e.g., an AP, such as the AP 110 of FIG. 1 and/or the AP 410 of FIG. 4), or by a component or system (e.g., a chipset) of the network device. The operations of the process 1200 may be implemented as software components that are executed and run on one or more processors (e.g., processor 1410 of FIG. 14 or other processor(s)). Further, the transmission and reception of signals by the network device in the process 1200 may be enabled, for example, by one or more antennas and/or one or more transceivers such as one or more wireless transceiver(s) (e.g., communication interface 1440 of FIG. 14).

At block 1210, the network device (or component thereof) can determine, whether a channel map update (CMU) process is ongoing. For example, the master device can receive a communication (e.g., a packet) with a flag indicating that the CMU is ongoing (or in process). In some cases, the PAST is transmitted during the CMU process.

At block 1220, the network device (or component thereof) can add a current channel map to a channel map field of a protocol data unit (PDU) for periodic advertising synchronization transfer procedure (PAST) or appending CMU information to the PDU for the PAST based on whether the CMU process is ongoing. In some cases, the CMU information includes a channel map of the CMU process and an instant of the CMU process. For instance, the instant of the CMU process can be a time when the channel map of the CMU process is used by the network device for transmissions.

In one illustrative example, to add the current channel map to the channel map field of the PDU for PAST or appending CMU information to the PDU for the PAST, the network device (or component thereof) can add the current channel map to the channel map field of the PDU for PAST based on determining the CMU process is not ongoing. For instance, as described above with respect to FIG. 9, if the network device determines that the CMU is not ongoing, the network device can fill the channel map field (e.g., the ChM field) of the PDU with the current channel map (e.g., the old channel map), as shown in the format 800 of FIG. 8A. In one illustrative example, to add the current channel map to the channel map field of the PDU for PAST or appending CMU information to the PDU for the PAST, the network device (or component thereof) can append the CMU information to the PDU for the PAST based on determining the CMU process is ongoing. For instance, if the network device determines that the CMU is ongoing, at block 970, the network device can append the CMU information to the PDU for PAST, as shown in the format 850 of FIG. 8B.

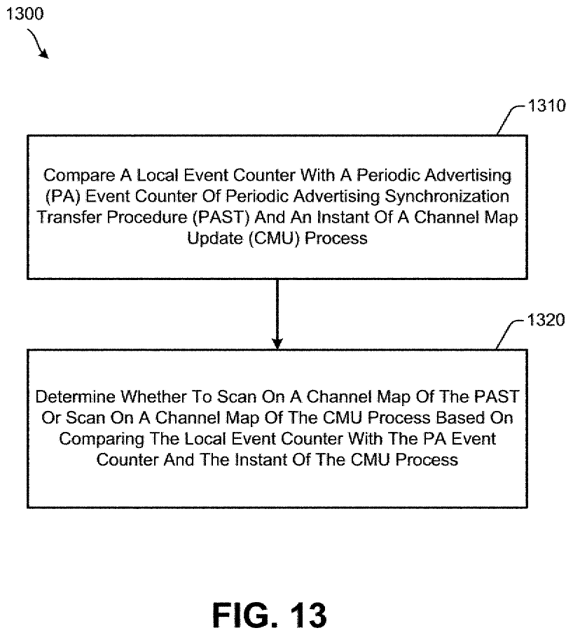

FIG. 13 is a flow chart illustrating an example of a process 1300 for wireless communications utilizing methods for optimizing the PDU payload of PAST to enhance the success rate of association and resynchronization of a wireless communication device system (e.g., an ESL system). The process 1300 can be performed by a wireless communication device (e.g., an ESL, such as wireless communication device 120 of FIG. 1 and/or ESL 1 420a of FIG. 4), such as a slave device, or by a component or system (e.g., a chipset) of the wireless communication device. The operations of the process 1300 may be implemented as software components that are executed and run on one or more processors (e.g., processor 1410 of FIG. 14 or other processor(s)). Further, the transmission and reception of signals by the wireless communications device in the process 1300 may be enabled, for example, by one or more antennas and/or one or more transceivers such as one or more wireless transceiver(s) (e.g., communication interface 1440 of FIG. 14).

At block 1310, the wireless communication device (or component thereof) can compare a local event counter with a periodic advertising (PA) event counter of periodic advertising synchronization transfer procedure (PAST) and an instant of a channel map update (CMU) process. For instance, the instant can be a time when the channel map of the CMU process is used by a network device (e.g., an access point) for transmissions. In some cases, the PAST is transmitted during the CMU process.

At block 1320, the wireless communication device (or component thereof) can determine whether to scan on a channel map of the PAST or scan on a channel map of the CMU process based on comparing the local event counter with the PA event counter and the instant of the CMU process. For instance, as described above with respect to FIG. 10, if the wireless communication device determines that the slave device was able to establish PA Sync, the wireless communication device can compare the local eventCounter (e.g., local event counter) with the PA EventCounter and the Instant.

In one illustrative example, to determine whether to scan on the channel map of the PAST or scan on the channel map of the CMU process, the wireless communication device (or component thereof) can scan on the channel map of the PAST based on determining the PA event counter for the PAST is less than or equal to the local event counter, and the local event counter is less than the instant of the CMU process. For instance, as described above with respect to FIG. 10, if the wireless communication device determines that the PA event counter (e.g., PA EventCounter) for the PAST is less than or equal to the local event counter (e.g., local eventCounter) and that the local event counter is less than the Instant of the CMU process, the wireless communication device can scan using the PAST channel map (e.g., scan on the ChM_PAST). However, if the wireless communication device determines that the Instant is less than or equal to the local event counter (e.g., local eventCounter), and the local event counter is less than the PA event counter (e.g., PA EventCounter), the wireless communication device can scan using the CMU channel map (e.g., scan on the ChM_CMU).

In some cases, to determine whether to scan on the channel map of the PAST or scan on the channel map of the CMU process, the wireless communication device (or component thereof) can scan on the channel map of the CMU process based on determining the instant of the CMU process is less than or equal to the local event counter, and the local event counter is less than the PA event counter for the PAST.

In some examples, the wireless communication device (or component thereof) can determine whether a protocol data unit (PDU) for the PAST includes CMU information. For instance, the CMU information can include the channel map of the CMU process and the instant of the CMU process.

The network device (e.g., master device) and/or wireless communication device (e.g., slave device) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein.

The components of the network device (e.g., master device) configured to perform the process 700 of FIGS. 7, 900 of FIG. 9, and 1100 of FIG. 11, and/or the wireless communication device configured to perform the process 1000 of FIGS. 10 and 1200 of FIG. 12 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 700, 900, 1000, 1100, 1200 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 700, 900, 1000, 1100, 1200, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed by the disclosed systems and techniques for optimizing the PDU payload of PAST to enhance the success rate of association and resynchronization of a wireless communication device system (e.g., an ESL system). In particular, FIG. 14 illustrates an example of computing system 1400, which can be, for example, any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™M wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LIDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1 ) cache, Level 2 (L2 ) cache, Level 3 (L3 ) cache, Level 4 (L4 ) cache, Level 5 (L5 ) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A method of wireless communication performed at a network device, the method comprising: determining, by the network device, whether a channel map update (CMU) process is ongoing and whether a periodic advertising (PA) event counter of periodic advertising synchronization transfer procedure (PAST) is similar to an instant of the CMU process; and adding, by the network device, a current channel map or a channel map of the CMU process to a channel map field of a protocol data unit (PDU) for the PAST based on whether at least one of the CMU process is ongoing or whether the PA event counter of PAST is similar to the instant of the CMU process.
Aspect 2. The method of Aspect 1, wherein adding the current channel map or the channel map of the CMU process to the channel map field of the PDU for the PAST comprises: adding the current channel map to the channel map field of the PDU for the PAST based on determining at least one of the CMU process is not ongoing or the PA event counter of PAST is not similar to the instant of the CMU process.
Aspect 3. The method of any one of Aspects 1 or 2, wherein adding the current channel map or the channel map of the CMU process to the channel map field of the PDU for the PAST comprises: adding the channel map of the CMU process to the channel map field of the PDU for the PAST based on determining the CMU process is ongoing and the PA event counter of the PAST is similar to the instant of the CMU process.
Aspect 4. The method of any one of Aspects 1 to 3, wherein the network device is an access point.
Aspect 5. The method of any one of Aspects 1 to 4, wherein the PAST is transmitted during the CMU process.
Aspect 6. The method of any one of Aspects 1 to 5, wherein the instant of the CMU process is a time when the channel map of the CMU process is used by the network device for transmissions.
Aspect 7. The method of any one of Aspects 1 to 6, wherein determining whether the PA event counter of PAST is similar to the instant of the CMU process includes determining whether the PA event counter of PAST is equal to the instant of the CMU process.
Aspect 8. A network device for wireless communication, the network device comprising: at least one memory; and at least one processor coupled to the at least one memory and configured to: determine whether a channel map update (CMU) process is ongoing and whether a periodic advertising (PA) event counter of periodic advertising synchronization transfer procedure (PAST) is similar to an instant of the CMU process; and add a current channel map or a channel map of the CMU process to a channel map field of a protocol data unit (PDU) for the PAST based on whether at least one of the CMU process is ongoing or whether the PA event counter of PAST is similar to the instant of the CMU process.
Aspect 9. The network device of Aspect 8, wherein, to add the current channel map or the channel map of the CMU process to the channel map field of the PDU for the PAST, the at least one processor is configured to: add the current channel map to the channel map field of the PDU for the PAST based on determining at least one of the CMU process is not ongoing or the PA event counter of PAST is not similar to the instant of the CMU process.
Aspect 10. The network device of any one of Aspects 8 or 9, wherein, to add the current channel map or the channel map of the CMU process to the channel map field of the PDU for the PAST, the at least one processor is configured to: add the channel map of the CMU process to the channel map field of the PDU for the PAST based on determining the CMU process is ongoing and the PA event counter of the PAST is similar to the instant of the CMU process.
Aspect 11. The network device of any one of Aspects 8 to 10, wherein the network device is an access point.
Aspect 12. The network device of any one of Aspects 8 to 11, wherein the PAST is transmitted during the CMU process.
Aspect 13. The network device of any one of Aspects 8 to 12, wherein the instant of the CMU process is a time when the channel map of the CMU process is used by the network device for transmissions.
Aspect 14. The network device of any one of Aspects 8 to 13, wherein, to determine whether the PA event counter of PAST is similar to the instant of the CMU process, the at least one processor is configured to determine whether the PA event counter of PAST is equal to the instant of the CMU process.
Aspect 15. A method of wireless communication performed at a network device, the method comprising: determining, by the network device, whether a channel map update (CMU) process is ongoing; and adding, by the network device, a current channel map to a channel map field of a protocol data unit (PDU) for periodic advertising synchronization transfer procedure (PAST) or appending CMU information to the PDU for the PAST based on whether the CMU process is ongoing.
Aspect 16. The method of Aspect 15, wherein adding the current channel map to the channel map field of the PDU for PAST or appending CMU information to the PDU for the PAST comprises: adding the current channel map to the channel map field of the PDU for PAST based on determining the CMU process is not ongoing.
Aspect 17. The method of any one of Aspects 15 or 16, wherein adding the current channel map to the channel map field of the PDU for PAST or appending CMU information to the PDU for the PAST comprises: appending the CMU information to the PDU for the PAST based on determining the CMU process is ongoing.
Aspect 18. The method of any one of Aspects 15 to 17, wherein the network device is an access point.
Aspect 19. The method of any one of Aspects 15 to 18, wherein the PAST is transmitted during the CMU process.
Aspect 20. The method of any one of Aspects 15 to 19, wherein the CMU information comprises a channel map of the CMU process and an instant of the CMU process.
Aspect 21. The method of Aspect 20, wherein the instant of the CMU process is a time when the channel map of the CMU process is used by the network device for transmissions.
Aspect 22. A network device for wireless communication, the network device comprising: at least one memory; and at least one processor coupled to the at least one memory and configured to: determine whether a channel map update (CMU) process is ongoing; and add a current channel map to a channel map field of a protocol data unit (PDU) for periodic advertising synchronization transfer procedure (PAST) or appending CMU information to the PDU for the PAST based on whether the CMU process is ongoing.
Aspect 23. The network device of Aspect 22, wherein, to add the current channel map to the channel map field of the PDU for PAST or appending CMU information to the PDU for the PAST, the at least one processor is configured to: add the current channel map to the channel map field of the PDU for PAST based on determining the CMU process is not ongoing.
Aspect 24. The network device of any one of Aspects 22 or 23, wherein, to add the current channel map to the channel map field of the PDU for PAST or appending CMU information to the PDU for the PAST, the at least one processor is configured to: append the CMU information to the PDU for the PAST based on determining the CMU process is ongoing.
Aspect 25. The network device of any one of Aspects 22 to 24, wherein the network device is an access point.
Aspect 26. The network device of any one of Aspects 22 to 25, wherein the PAST is transmitted during the CMU process.
Aspect 27. The network device of any one of Aspects 22 to 26, wherein the CMU information comprises a channel map of the CMU process and an instant of the CMU process.
Aspect 28. The network device of Aspect 27, wherein the instant of the CMU process is a time when the channel map of the CMU process is used by the network device for transmissions.
Aspect 29. A method of wireless communication performed at a wireless communication device, the method comprising: comparing, by the wireless communication device, a local event counter with a periodic advertising (PA) event counter of periodic advertising synchronization transfer procedure (PAST) and an instant of a channel map update (CMU) process; and determining, by the wireless communication device, whether to scan on a channel map of the PAST or scan on a channel map of the CMU process based on comparing the local event counter with the PA event counter and the instant of the CMU process.
Aspect 30. The method of Aspect 29, wherein determining whether to scan on the channel map of the PAST or scan on the channel map of the CMU process comprises: scanning on the channel map of the PAST based on determining the PA event counter for the PAST is one of less than or equal to the local event counter, and the local event counter is less than the instant of the CMU process.
Aspect 31. The method of any one of Aspects 29 or 30, wherein determining whether to scan on the channel map of the PAST or scan on the channel map of the CMU process comprises: scanning on the channel map of the CMU process based on determining the instant of the CMU process is one of less than or equal to the local event counter, and the local event counter is less than the PA event counter for the PAST.
Aspect 32. The method of any one of Aspects 29 to 31, wherein the wireless communication device is an electronic shelf unit (ESL).
Aspect 33. The method of any one of Aspects 29 to 32, wherein the PAST is transmitted during the CMU process.
Aspect 34. The method of any one of Aspects 29 to 33, wherein the instant is a time when the channel map of the CMU process is used by a network device for transmissions.
Aspect 35. The method of Aspect 34, wherein the network device is an access point.
Aspect 36. The method of any one of Aspects 29 to 35, further comprising determining, by the wireless communication device, whether a protocol data unit (PDU) for the PAST comprises CMU information.
Aspect 37. The method of Aspect 36, wherein the CMU information comprises the channel map of the CMU process and the instant of the CMU process.
Aspect 38. A wireless communication device for wireless communication, the wireless communication device comprising: at least one memory; and at least one processor coupled to the at least one memory and configured to: compare a local event counter with a periodic advertising (PA) event counter of periodic advertising synchronization transfer procedure (PAST) and an instant of a channel map update (CMU) process; and determine whether to scan on a channel map of the PAST or scan on a channel map of the CMU process based on comparing the local event counter with the PA event counter and the instant of the CMU process.
Aspect 39. The wireless communication device of Aspect 38, wherein, to determine whether to scan on the channel map of the PAST or scan on the channel map of the CMU process, the at least one processor is configured to: scan on the channel map of the PAST based on determining the PA event counter for the PAST is one of less than or equal to the local event counter, and the local event counter is less than the instant of the CMU process.
Aspect 40. The wireless communication device of any one of Aspects 38 or 39, wherein, to determine whether to scan on the channel map of the PAST or scan on the channel map of the CMU process, the at least one processor is configured to: scan on the channel map of the CMU process based on determining the instant of the CMU process is one of less than or equal to the local event counter, and the local event counter is less than the PA event counter for the PAST.
Aspect 41. The wireless communication device of any one of Aspects 38 to 40, wherein the wireless communication device is an electronic shelf unit (ESL).
Aspect 42. The wireless communication device of any one of Aspects 38 to 41, wherein the PAST is transmitted during the CMU process.
Aspect 43. The wireless communication device of any one of Aspects 38 to 42, wherein the instant is a time when the channel map of the CMU process is used by a network device for transmissions.
Aspect 44. The wireless communication device of any one of Aspects 38 to 43, wherein the network device is an access point.
Aspect 45. The wireless communication device of any one of Aspects 38 to 44, wherein the at least one processor is configured to determine whether a protocol data unit (PDU) for the PAST comprises CMU information.
Aspect 46. The wireless communication device of any one of Aspects 38 to 45, wherein the CMU information comprises the channel map of the CMU process and the instant of the CMU process.
Aspect 47. A non-transitory computer-readable medium having stored thereon instructions that, when executed by at least one processor, cause the at least one processor to perform operation according to any of Aspects 1 to 7.
Aspect 48. An apparatus for wireless communication, comprising one or more means for performing operations according to any of Aspects 1 to 7.
Aspect 49. A non-transitory computer-readable medium having stored thereon instructions that, when executed by at least one processor, cause the at least one processor to perform operation according to any of Aspects 15 to 21.
Aspect 50. An apparatus for wireless communication, comprising one or more means for performing operations according to any of Aspects 15 to 21.
Aspect 51. A non-transitory computer-readable medium having stored thereon instructions that, when executed by at least one processor, cause the at least one processor to perform operation according to any of Aspects 29 to 37.
Aspect 52. An apparatus for wireless communication, comprising one or more means for performing operations according to any of Aspects 29 to 37.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A method of wireless communication performed at a network device, the method comprising:
determining, by the network device, whether a channel map update (CMU) process is ongoing and whether a periodic advertising (PA) event counter of periodic advertising synchronization transfer procedure (PAST) is similar to an instant of the CMU process; and
adding, by the network device, a current channel map or a channel map of the CMU process to a channel map field of a protocol data unit (PDU) for the PAST based on whether at least one of the CMU process is ongoing or whether the PA event counter of PAST is similar to the instant of the CMU process.

2. The method of claim 1, wherein adding the current channel map or the channel map of the CMU process to the channel map field of the PDU for the PAST comprises:
adding the current channel map to the channel map field of the PDU for the PAST based on determining at least one of the CMU process is not ongoing or the PA event counter of PAST is not similar to the instant of the CMU process.

3. The method of claim 1, wherein adding the current channel map or the channel map of the CMU process to the channel map field of the PDU for the PAST comprises:
adding the channel map of the CMU process to the channel map field of the PDU for the PAST based on determining the CMU process is ongoing and the PA event counter of the PAST is similar to the instant of the CMU process.

4. The method of claim 1, wherein the network device is an access point.

5. The method of claim 1, wherein the PAST is transmitted during the CMU process.

6. The method of claim 1, wherein the instant of the CMU process is a time when the channel map of the CMU process is used by the network device for transmissions.

7. The method of claim 1, wherein determining whether the PA event counter of PAST is similar to the instant of the CMU process includes determining whether the PA event counter of PAST is equal to the instant of the CMU process.

8. A network device for wireless communication, the network device comprising:
at least one memory; and
at least one processor coupled to the at least one memory and configured to:
determine whether a channel map update (CMU) process is ongoing and whether a periodic advertising (PA) event counter of periodic advertising synchronization transfer procedure (PAST) is similar to an instant of the CMU process; and
add a current channel map or a channel map of the CMU process to a channel map field of a protocol data unit (PDU) for the PAST based on whether at least one of the CMU process is ongoing or whether the PA event counter of PAST is similar to the instant of the CMU process.

9. The network device of claim 8, wherein, to add the current channel map or the channel map of the CMU process to the channel map field of the PDU for the PAST, the at least one processor is configured to:
add the current channel map to the channel map field of the PDU for the PAST based on determining at least one of the CMU process is not ongoing or the PA event counter of PAST is not similar to the instant of the CMU process.

10. The network device of claim 8, wherein, to add the current channel map or the channel map of the CMU process to the channel map field of the PDU for the PAST, the at least one processor is configured to:
add the channel map of the CMU process to the channel map field of the PDU for the PAST based on determining the CMU process is ongoing and the PA event counter of the PAST is similar to the instant of the CMU process.

11. The network device of claim 8, wherein the network device is an access point.

12. The network device of claim 8, wherein the PAST is transmitted during the CMU process.

13. The network device of claim 8, wherein the instant of the CMU process is a time when the channel map of the CMU process is used by the network device for transmissions.

14. The network device of claim 8, wherein, to determine whether the PA event counter of PAST is similar to the instant of the CMU process, the at least one processor is configured to determine whether the PA event counter of PAST is equal to the instant of the CMU process.

15. A method of wireless communication performed at a network device, the method comprising:
determining, by the network device, whether a channel map update (CMU) process is ongoing; and
adding, by the network device, a current channel map to a channel map field of a protocol data unit (PDU) for periodic advertising synchronization transfer procedure (PAST) or appending CMU information to the PDU for the PAST based on whether the CMU process is ongoing.

16. The method of claim 15, wherein adding the current channel map to the channel map field of the PDU for PAST or appending CMU information to the PDU for the PAST comprises:
adding the current channel map to the channel map field of the PDU for PAST based on determining the CMU process is not ongoing.

17. The method of claim 15, wherein adding the current channel map to the channel map field of the PDU for PAST or appending CMU information to the PDU for the PAST comprises:
appending the CMU information to the PDU for the PAST based on determining the CMU process is ongoing.

18. (canceled)

19. The method of claim 15, wherein the PAST is transmitted during the CMU process.

20. The method of claim 15, wherein the CMU information comprises a channel map of the CMU process and an instant of the CMU process.

21. The method of claim 20, wherein the instant of the CMU process is a time when the channel map of the CMU process is used by the network device for transmissions.

22-28. (canceled)
